(19) United States
(12) Patent Application Publication
(10) Pub. No.: US 2026/0300280 A1
(43) Pub. Date: Oct. 1, 2026

(54) DYNAMIC SHELL HISTORY COMMAND

(71) Applicant: INTERNATIONAL BUSINESS MACHINES CORPORATION, Armonk, NY (US)

(72) Inventors: Zhan Peng Huo, Beijing (CN); Jiu Chang Du, Beijing (CN); Kui Zhang, BEIJING (CN); Peng Hui Jiang, Beijing (CN)

(21) Appl. No.: 19/092,412

(22) Filed: Mar. 27, 2025

(51) Int. Cl. G06F 16/242; G06F 9/50

(52) U.S. Cl. CPC G06F 16/2445; G06F 9/5016; G06F 2209/503

(57) ABSTRACT

A method, system, and computer program product configured to perform operations including: generating a data structure comprising a command field and a dynamic parameter field; retrieving a first command from a command history repository; determining that a first dynamic resource associated with the first command in the data structure is unavailable; determining that a second dynamic resource not associated with the first command in the data structure is available, where the second dynamic resource is operable to execute the first command; generating an updated data structure by updating the dynamic parameter field to include the second dynamic resource; and rendering, at a user device in real time, an updated command history based on the updated data structure.

### BACKGROUND

Aspects of the present invention relate generally to dynamic shell history command structures.

A shell command is a text-based instruction that a user (e.g., programmer) may enter at a command-line interface (CLI) to instruct the computer to perform a specific task. These commands are interpreted by a program called a shell, which acts as an interface between the user and an operating system. In modern development and operational environments, shell commands are used in system administration, scripting, automation, and development. Typically, shell history serves as a record of previously executed commands, allowing users to retrieve, re-run, or modify commands based on past work.

### SUMMARY

In a first aspect of the invention, there is a method including: generating a data structure comprising a command field and a dynamic parameter field; retrieving a first command from a command history repository; determining that a first dynamic resource associated with the first command in the data structure is unavailable; determining that a second dynamic resource not associated with the first command in the data structure is available, where the second dynamic resource is operable to execute the first command; generating an updated data structure by updating the dynamic parameter field to include the second dynamic resource; and rendering, at a user device in real time, an updated command history based on the updated data structure.

In another aspect of the invention, there is a computer program product comprising one or more computer-readable storage media and program instructions stored on the one or more computer-readable storage media to perform operations comprising: generating a data structure comprising a command field and a dynamic parameter field; retrieving a first command from a command history repository; determining that a first dynamic resource associated with the first command in the data structure is unavailable; determining that a second dynamic resource not associated with the first command in the data structure is available, where the second dynamic resource is operable to execute the first command; generating an updated data structure by updating the dynamic parameter field to include the second dynamic resource; and rendering, at a user device in real time, an updated command history based on the updated data structure.

In another aspect of the invention, there is a computer system comprising a processor set, one or more computer-readable storage media, and program instructions stored on the one or more computer-readable storage media to cause the processor set to perform operations comprising: generating a data structure comprising a command field and a dynamic parameter field; retrieving a first command from a command history repository; determining that a first dynamic resource associated with the first command in the data structure is unavailable; determining that a second dynamic resource not associated with the first command in the data structure is available, where the second dynamic resource is operable to execute the first command; generating an updated data structure by updating the dynamic parameter field to include the second dynamic resource; and rendering, at a user device in real time, an updated command history based on the updated data structure.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

FIG. 5 shows a flowchart of an exemplary method in accordance with aspects of the present invention.

FIG. 6 shows a flowchart of an exemplary method in accordance with aspects of the present invention.

FIG. 7 shows a flowchart of an exemplary data structure in accordance with aspects of the present invention.

### DETAILED DESCRIPTION

Aspects of the present invention relate generally to methods, systems, and computer program products for generating and maintaining dynamic shell history command structures.

Known shell history command systems present challenges in shell history usage. In modern development and operational environments, shell commands are used in system administration, scripting, automation, and development. Typically, a shell history serves as a record of previously executed commands, allowing users to retrieve, re-run, or modify commands based on past work. However, known shell histories are static and lack contextual awareness, which limits their ability to assist users in efficiently executing commands that relate to the current task or environment. Specifically, users must manually adjust and/or recheck their historical commands which increases the number of errors, requires significant amounts of time, and is inefficient. Therefore, known systems suffer from the problem of not being able to intelligently suggest and/or adapt previously executed commands based on the user's current activity and/or environment, leading to inefficiencies and errors in command usage.

Implementations of the invention address this problem by providing a method, system, and computer program product that intelligently adapts previously executed commands based on the user's current activity and/or environment into a new data structure easily accessible for a user, leading to improvements to a computer (e.g., more accurate and more efficient computing) and improvements to the technology of shell command histories (e.g., commands adapted to the user's current activity). Various embodiments enhance the usability and effectiveness of shell histories by making them dynamic and context-aware, allowing the system to offer more relevant, timely, and accurate command suggestions, ultimately reducing user errors and time spent searching through past commands.

According to an aspect of the present invention, the method, system, and computer program product include: generating a data structure for a bourne again shell (bash) .bash_history file, configured to dynamically render shell history command data; detecting a user input in real time using a real time resource detection module; extracting and abstracting data paths and dynamic parameters (e.g., dynamic resources) of a shell command based on the user input; storing the extracted and abstracted data paths and dynamic parameters of the shell command in the . bash_history file; rendering a selected record in .bash_history file such that a user can observe the updated . bash_history file in real time. In embodiments, by integrating real time resource detection, data extraction, and abstraction, the system enables more adaptive and responsive command history tracking. According to aspects of the invention, user's may implement embodiments in practical applications such as real time command tracking and debugging (e.g., users can observe and modify their shell command history in real time), enhanced automation and scripting (e.g., developers can use the updated .bash_history data structure to create automated workflows that adapt based on available resources), context-aware shell usage (e.g., for developers working across multiple servers, aspects of the invention enables dynamic adjustment of commands based on the specific system they are using), and more. According to aspects of the invention, a .bash_history becomes more than just a static log—embodiments transform the .bash_history into a real time, intelligent execution assistant that dynamically updates command history based on available resources and user interactions. This enhances efficiency, automation, and security in command-line environments.

According to an aspect of the invention, there is a method that includes generating a data structure comprising a command field and a dynamic parameter field; retrieving a first command from a command history repository; determining that a first dynamic resource associated with the first command in the data structure is unavailable; determining that a second dynamic resource not associated with the first command in the data structure is available, wherein the second dynamic resource is operable to execute the first command; generating an updated data structure by updating the dynamic parameter field to include the second dynamic resource; and rendering, at a user device in real time, an updated command history based on the updated data structure. The foregoing features provide a method that overcomes problems in the existing technology by dynamically generating and updating commands stored in data structures so the commands can execute despite resource unavailability. Thereby creating a more resilient and adaptive method for command execution and history management in real time.

In embodiments, the data structure further includes a field indicating a presence of a suggested data change. By providing a method capable of tracking and flagging modifications in stored commands, the method will provide a mechanism to identify updates, thereby providing a more efficient and automated approach to command execution adjustments.

In embodiments, the method further includes setting a flag in the field indicating the presence of the suggested data change. By providing a method capable of automatically signaling potential modifications, the method will provide a clear indication of updates, thereby providing a streamlined approach to data consistency.

In embodiments, the method further includes removing the flag in response to making the suggested data change. By providing a method capable of automatically clearing modification indicators upon update, the method will provide a self-maintaining system for tracking executed changes, thereby providing a more reliable and automated process for data structure updates.

In embodiments, the updated data structure is further generated based on a context change associated with a user input. By providing a method capable of adapting command structures based on real-time user interactions, the method will provide dynamic adjustment mechanism, thereby providing a more responsive and context-aware system.

In embodiments, the context comprises a variable selected from a group consisting of: an environment variable, a current state variable, and an available system resource variable. By providing a method capable of integrating diverse system states into decision-making, the method will provide a context-sensitive execution framework, thereby providing a more intelligent and efficient command execution process.

In embodiments, the first dynamic resource is a resource selected from a group consisting of an internet protocol address, a file path, a port number, a directory permission, and an amount of available disk space. By providing a method capable of identifying and substituting system resources dynamically, the method will provide a flexible approach to command execution, thereby providing a more resilient and resource-efficient computing environment.

In embodiments, generating the updated data structure further comprises removing the first dynamic resource from the dynamic parameter field and updating the command to call the second dynamic resource. By providing a method capable of replacing unavailable resources with alternative resources in real-time, the method will provide a seamless execution flow, thereby providing a fault-tolerant and adaptable system for managing resource-dependent commands.

According to an aspect of the invention, there is a computer program product that includes one or more computer-readable storage media; and program instructions stored on the one or more computer-readable storage media to perform operations. The operations include: generating a data structure comprising a command field and a dynamic parameter field; retrieving a first command from a command history repository; determining that a first dynamic resource associated with the first command in the data structure is unavailable; determining that a second dynamic resource not associated with the first command in the data structure is available, wherein the second dynamic resource is operable to execute the first command; generating an updated data structure by updating the dynamic parameter field to include the second dynamic resource; and rendering, at a user device in real time, an updated command history based on the updated data structure. The foregoing features provide a computer program product that overcomes problems in the existing technology by dynamically generating and updating commands stored in data structures so the commands can execute despite resource unavailability. Thereby creating a more resilient and adaptive method for command execution and history management in real time.

In embodiments, the data structure further includes a field indicating a presence of a suggested data change. By providing a computer program product capable of tracking and flagging modifications in stored commands, the computer program product will provide a mechanism to identify updates, thereby providing a more efficient and automated approach to command execution adjustments.

In embodiments, the operations further include setting a flag in the field indicating the presence of the suggested data change. By providing a computer program product capable of automatically signaling potential modifications, the computer program product will provide a clear indication of updates, thereby providing a streamlined approach to data consistency.

In embodiments, the operations further include removing the flag in response to making the suggested data change. By providing a computer program product capable of automatically clearing modification indicators upon update, the computer program product will provide a self-maintaining system for tracking executed changes, thereby providing a more reliable and automated process for data structure updates.

In embodiments, the updated data structure is further generated based on a context change associated with a user input. By providing a computer program product capable of adapting command structures based on real-time user interactions, the computer program product will provide a dynamic adjustment mechanism, thereby providing a more responsive and context-aware system.

In embodiments, the context comprises a variable selected from a group consisting of: an environment variable, a current state variable, and an available system resource variable. By providing a computer program product capable of integrating diverse system states into decision-making, the computer program product will provide a context-sensitive execution framework, thereby providing a more intelligent and efficient command execution process.

According to an aspect of the invention, there is a system that includes a processor set; one or more computer-readable storage media; and program instructions stored on the one or more computer-readable storage media to cause the processor set to perform operations. The operations include: generating a data structure comprising a command field and a dynamic parameter field; retrieving a first command from a command history repository; determining that a first dynamic resource associated with the first command in the data structure is unavailable; determining that a second dynamic resource not associated with the first command in the data structure is available, wherein the second dynamic resource is operable to execute the first command; generating an updated data structure by updating the dynamic parameter field to include the second dynamic resource; and rendering, at a user device in real time, an updated command history based on the updated data structure. The foregoing features provide a system that overcomes problems in the existing technology by dynamically generating and updating commands stored in data structures so the commands can execute despite resource unavailability. Thereby creating a more resilient and adaptive method for command execution and history management in real time.

In embodiments, the data structure further includes a field indicating a presence of a suggested data change. By providing a system capable of tracking and flagging modifications in stored commands, the system will provide a mechanism to identify updates, thereby providing a more efficient and automated approach to command execution adjustments.

In embodiments, the operations further include setting a flag in the field indicating the presence of the suggested data change. By providing a system capable of automatically signaling potential modifications, the system will provide a clear indication of updates, thereby providing a streamlined approach to data consistency.

In embodiments, the operations further include removing the flag in response to making the suggested data change. By providing a system capable of automatically clearing modification indicators upon update, the system will provide a self-maintaining system for tracking executed changes, thereby providing a more reliable and automated process for data structure updates.

In embodiments, the first dynamic resource is a resource selected from a group consisting of an internet protocol address, a file path, a port number, a directory permission, and an amount of available disk space. By providing a system capable of identifying and substituting system resources dynamically, the system will provide a flexible approach to command execution, thereby providing a more resilient and resource-efficient computing environment.

In embodiments, generating the updated data structure further comprises removing the first dynamic resource from the dynamic parameter field and updating the command to call the second dynamic resource. By providing a system capable of replacing unavailable resources with alternative resources in real-time, the system will provide a seamless execution flow, thereby providing a fault-tolerant and adaptable system for managing resource-dependent commands.

As used herein, a shell command history (e.g., a .bash_history file) is a feature in a command-line interface that keeps track of the commands a user executes. For example, in embodiments, the shell command history functions like a log or record of the commands run in the shell, allowing users to view, re-run, and/or edit previously executed commands without needing to type them again. As used herein, dynamic parameters (e.g., dynamic resources) refer to variables or values that change over time or in response to system or environmental conditions. These parameters are associated with shell commands and can impact the execution or result of those commands. In embodiments, dynamic parameters may include an internet protocol address, a file path, a port number, a directory permission, an amount of available disk space, and/or any other system or environment-specific value that can change during runtime, such as memory usage, CPU load, system configuration settings, or network availability. These dynamic parameters are recorded and updated in real time to ensure the most current and relevant data is captured in the command history (e.g., shell command history).

Implementations of the present invention are necessarily rooted in computer technology. For example, generating a data structure comprising a command field and a dynamic parameter field; retrieving a first command from a command history repository and rendering an updated command history based on the updated data structure at a user device in real time are computer-based and cannot be performed in the human mind.

It should be understood that, to the extent implementations of the present invention collect, store, or employ personal information provided by, or obtained from, individuals (e.g., information captured in the generated and rendered shell history command data), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as novel dynamic shell history command code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

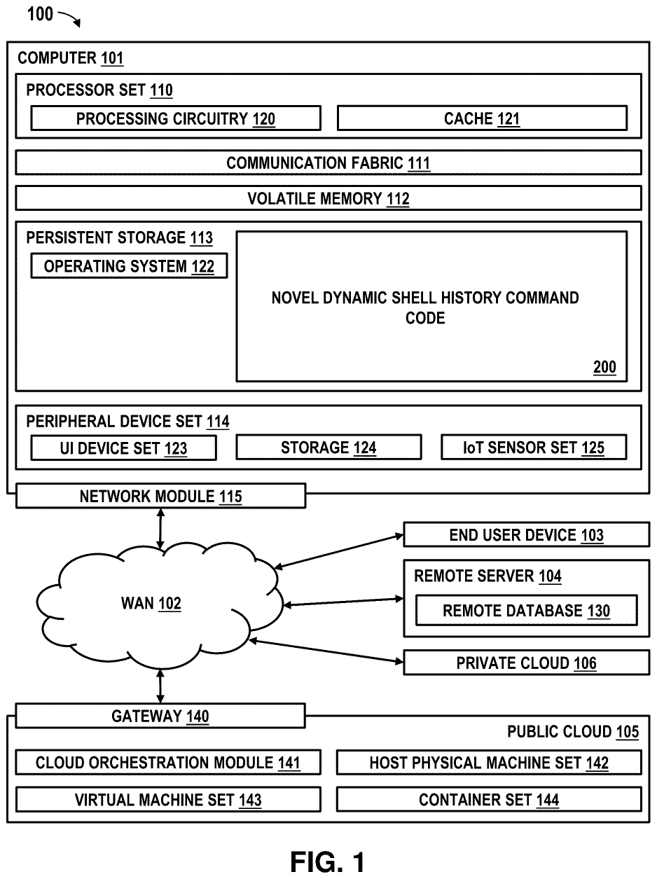

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102.

Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

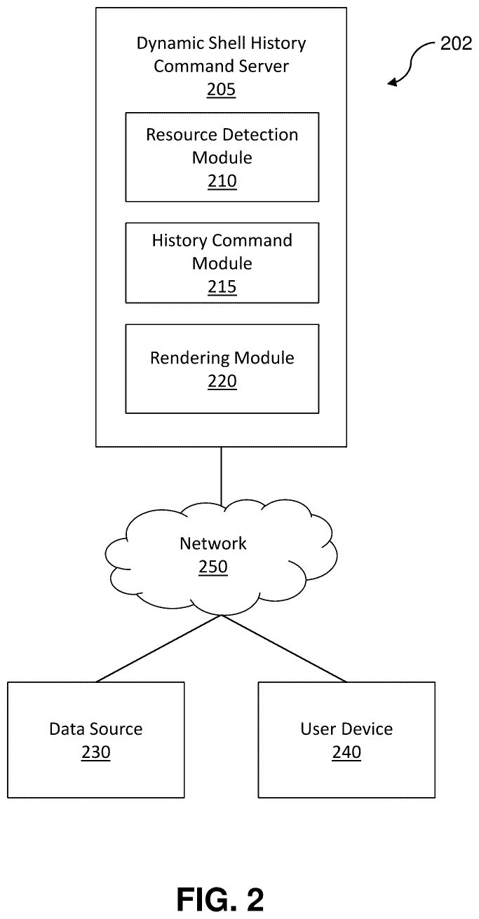

FIG. 2 shows a block diagram of exemplary environment 202 in accordance with aspects of the present invention. In embodiments, environment 202 includes dynamic shell history command server 205, data source 230, user device 240, and network 250.

Dynamic shell history command server 205 may comprise one or more instances of computer 101 of FIG. 1. In another example dynamic shell history command server 205 may comprise one or more virtual machines or containers running on one or more instances of computer 101 of FIG. 1. In embodiments, dynamic shell history command server 205 communicates with data source 230 and user device 240 via network 250, which may comprise WAN 102 of FIG. 1. In embodiments, data source 230 may comprise one or more data sources each comprising an instance of remote database 130 and/or remote server 104 of FIG. 1. In embodiments, user device 240 comprises an instance of EUD 103 of FIG. 1. There may be plural different instances of user device 240 including, for example, personal computing devices or any other device capable of using and rendering a dynamic shell history command. The different instances of user device 240 may be used by different users, programmers, evaluators, operators, technicians, etc.

In embodiments, dynamic shell history command server 205 of FIG. 2 comprises resource detection module 210, history command module 215, and rendering module 220, each of which may comprise modules of the code of block 200 of FIG. 1. Such modules may include routines, programs, objects, components, logic, data structures, and so on that perform a particular task (or tasks) or implement a particular data type (or types) that the code of block 200 uses to carry out the functions and/or methodologies of embodiments of the present invention as described herein. These modules of the code of block 200 are executable by computer 101 of FIG. 1 (e.g., processing circuitry 120 of FIG. 1) to perform the inventive methods as described herein. dynamic shell history command server 205 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, dynamic shell history command server 205 is configured to facilitate communication between resource detection module 210, history command module 215, rendering module 220, and external storage (e.g., data source 230) and devices (e.g., user device 240) via network 250.

In embodiments, dynamic shell history command server 205 may be configured to generate a data structure for maintaining a dynamic shell history at (e.g., within) a bash_history file. As used herein, a bash_history file refers to a file used by a bash shell in Unix-based systems to record commands executed by the user. In embodiments, the generated data structure comprises a command field, a file path field, a dynamic parameter field, a note field, and a flag field. A command field refers to a field in the data structure indicating a shell command that was previously and/or can be executed by the user. A file path field refers to a field in the data structure indicating the location of the file or directory that was and/or is involved in the command execution. A dynamic parameter field refers to a field in the data structure indicating values that can change dynamically based on the command context, such as an internet protocol (IP) address, a file path, a port number, a directory permission, an amount of available disk space, and/or other parameters associated with executing a shell history command. A note field refers to a field within the data structure that may contain plain-text notes describing suggested changes to a command, a file path, and/or a dynamic resource (e.g., dynamic parameter). A flag field refers to a field in the data structure indicating the presence or absence of a suggested data change (e.g., whether a command, file path, and/or dynamic resource has been modified and/or is suggested for modification).

In embodiments, the bash_history file allows for the retrieval and/or re-execution of past commands. In embodiments, the bash_history file stores the past commands in a plain-text format. In some embodiments, dynamic shell history command server 205 may write and/or save the data structure directly to the bash_history file. Whereas in other embodiments, dynamic shell history command server 205 may provide the data structure to a processor and/or user device (e.g., user device 240) to incorporate the data structure into the bash_history file.

In accordance with aspects of the present invention, resource detection module 210 may be configured to retrieve a first command from a command history repository (e.g., data source 230) and determine whether a first dynamic resource (e.g., dynamic parameter) associated with the first command is available. In such embodiments, resource detection module 210 detects, in real time, shell commands that are inputted and/or used by the user. Resource detection module 210 further extracts and/or abstracts any file paths and/or dynamic parameters associated with the detected shell command. In such embodiments, resource detection module 210 may check whether one or more shell commands call, list, invoke, and/or use a dynamic resource and perform availability checks on the dynamic resources called, listed, invoked, and/or used in the command.

In embodiments, when a dynamic resource and/or the availability of a dynamic resource has changed (e.g., when the dynamic resource is not or is no longer available), resource detection module 210 may set a flag in the data structure flag field, indicating a suggested data change. As used herein, a flag refers to a binary indicator and/or marker within the data structure that signals the presence or absence of a particular condition, event, or suggested change. In this context, it indicates whether a dynamic resource has changed and/or if a change is suggested in the data, such as modifications to a command, a file path, and/or a dynamic resource. In embodiments, a flag may hold a value such as “true” or “false,” “1” or “0 ,” or other Boolean representations to reflect the status of the change and/or condition. In embodiments, when the data structure and/or bash_history file is updated to reflect the flagged change and/or condition, resource detection module 210 may remove the flag.

In embodiments, when a dynamic resource and/or the availability of a dynamic resource has changed (e.g., when the dynamic resource is not or is no longer available), resource detection module 210 may prepare, write, include, and/or generate a plain text note in the data structure note field, describing suggested changes to a command, a file path, and/or a dynamic resource.

For example, if a previously used port is no longer available, resource detection module 210 may generate a note indicating a new port that may be used for executing the associated command.

In accordance with aspects of the present invention, resource detection module 210 is further configured to generate an updated data structure by merging an updated dynamic resource into the dynamic parameter field of the bash_history file. For example, when a dynamic resource requires updating, the data structure is updated to reflect the change and/or to reflect the updated information to provide the available dynamic resource. This ensures that the dynamic parameter field in the bash_history file always contains the most current and relevant information, such as an updated IP address, file path, and/or available disk space, reflecting any changes to the system, environment, and or context the user is working in. As used herein, context refers to an environment variable, a current state variable, and/or an available system resource variable. In embodiments, these elements define the operational conditions and/or parameters in which a user is working, such as system settings, available resources (like memory or disk space), and/or other dynamic factors that can influence the behavior and execution of commands within the shell. Context can change over time based on the system's state, the user's actions, and/or external conditions affecting the environment. In this manner, the generated and updated data structure always contains the most current and relevant information associated with the real-time context, thereby providing an improvement to the operation of a computer and an improvement to the field of shell command history management.

In accordance with aspects of the present invention, history command module 215 is configured to maintain unchanged data structure information, including unchanged dynamic resources. For example, in embodiments, history command module 215 ensures that unchanged data structure information, such as static system settings, fixed configuration parameters (e.g., user name, system hostname, or default directory paths), and/or unchanged dynamic resources remains consistent in the bash_history file, preventing unnecessary updates while still maintaining accurate historical command context.

In accordance with aspects of the present invention, rendering module 220 is configured to render a command history file associated with the updated data structure at a user device in real time. For example, when a change or update occurs in the dynamic resource and/or context, rendering module 220 updates and displays the modified command history file on a user device (e.g., user device 240), ensuring that the user has access to the most up-to-date version of the history file. This allows the user to view and interact with the command history in real time, with any changes to commands, file paths, and/or dynamic resources reflected in real time.

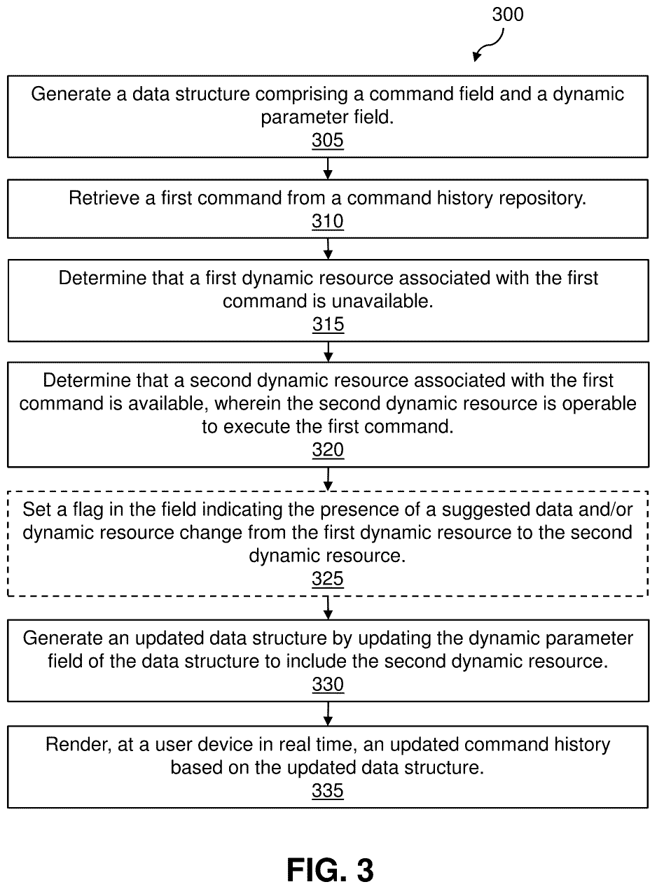

FIG. 3 shows a flow diagram of an exemplary method 300 in accordance with aspects of the present invention. Operations of the method 300 are described with reference to elements and actions depicted in and described with reference to FIG. 2.

At operation 305, the system (e.g., dynamic shell history command server 205 of FIG. 2) is configured to generate a data structure comprising a command field, a dynamic parameter field, a note field, a flag field, and/or other fields configured to store data related to a command. As used herein, a data structure refers to an organized collection of data elements that are stored and managed in a specific format, allowing efficient access, modification, and management of data. In embodiments, the structure can be designed to store various types of information in fields or attributes, with each field dedicated to a specific type of data. In embodiments, the data structure is configured to hold shell history command data, including fields like a command field (storing the executed command), a dynamic parameter field (storing dynamic resources or parameters associated with that command, such as IP addresses, file paths, etc.), and more. Operation 305 may be performed in accordance with the descriptions and embodiments of dynamic shell history command server 205 of FIG. 2.

At operation 310, the system (e.g., resource detection module 210 of FIG. 2) is configured to retrieve a first command from a command history repository (e.g., data source 230 of FIG. 2). As used herein, a command history repository refers to a storage location, such as a database and/or file system, where shell commands previously executed by a user and/or a system are logged and/or stored. In embodiments, the command history repository enables efficient access to prior commands and/or their associated metadata, facilitating the retrieval of commands for reuse and/or further processing.

In embodiments, the system may retrieve the first command from the command history repository in response to a user input (e.g., a user request, call, etc.) to view a command history. For example, the user could issue a specific command like “history” or “show commands,” prompting the system to display previously executed commands. In other embodiments, the system may retrieve the first command from the command history repository in response to an automatic system process and/or event, such as a scheduled task, a script to be executed, and/or a system notification that references past commands for troubleshooting or analysis. In embodiments, operation 310 may be performed in accordance with the descriptions and embodiments of resource detection module 210 of FIG. 2.

At operation 315, the system (e.g., resource detection module 210 of FIG. 2) is configured to determine and/or identify that a first dynamic resource associated with the first command is unavailable. In embodiments, the system may run scripts and/or resource availability check functions (e.g., check_ip( ), check_port( ), check_dir_permission( ), check_space). For example, the system may run a check_ip( ) function to verify whether a remote server IP address is reachable or if the server is down. In embodiments, the system might use a check_port( ) function to confirm whether a specific network port used by the command is open or closed. Similarly, in embodiments, the system may perform a check_dir_permission( ) function to determine whether the user has the necessary permissions to access a specific directory. In embodiments, the system may perform a check_space( ) function could verify if sufficient disk space is available for executing the command. In embodiments, the system may also, or alternatively, perform other functions for determining and/or identifying a resource availability. Operation 315 may be performed in accordance with the descriptions and embodiments of resource detection module 210 of FIG. 2.

At operation 320, the system (e.g., resource detection module 210 of FIG. 2) is configured to determine that a second dynamic resource operatable to execute the first command is available. In embodiments, the second dynamic resource is operable to execute the first command in the same and/or similar manner as the first dynamic resource. As used herein, a dynamic resource being operable to execute a command refers to a dynamic resource having the necessary attributes, capabilities, and/or configurations to perform the same (or similar) function and/or task that the unavailable first dynamic resource was intended to perform. For example, if the first dynamic resource indicates a specific port (e.g., port: 81) and the second dynamic resource indicates another port (e.g., port: 87), the second port should be able to run the same command, potentially with similar environmental configurations and/or system states as the first port, to produce the same or similar results. Operation 320 may be performed in accordance with the descriptions and embodiments of operation 315 of FIG. 3 and resource detection module 210 of FIG. 2.

At operation 325, the system (e.g., resource detection module 210 of FIG. 2) is optionally (as indicated by dotted lines) configured to set a flag in the field indicating the presence of a suggested data change. As noted above, a flag may hold a value such as “true” or “false,” “1” or “0 ,” or other Boolean representations to reflect the status of the change and/or condition. For example, if the first dynamic resource (e.g., port: 81) is unavailable, but the second dynamic resource (e.g., port: 87) is available, the system may set the flag in real time to indicate that a change should be made from the first dynamic resource to the second dynamic resource. Setting a flag provides a way to automatically track potential updates to the command, enabling the system to notify users and/or trigger automated corrections. This also allows for more dynamic and efficient handling of commands, as the system can proactively suggest and/or apply resource changes in response to availability issues. Operation 325 may be performed in accordance with the description and embodiments of resource detection module 210 of FIG. 2.

At operation 335, the system (e.g., resource detection module 210 of FIG. 2) is configured to generate an updated data structure by updating the dynamic parameter field of the data structure to include the second dynamic resource. For example, this is performed by replacing the first dynamic resource (e.g., file path “x”) with the second dynamic resource (e.g., file path “y”) in the dynamic parameter field such that the updated data structure associates the second dynamic resource (e.g., file path “y”) with the command. In embodiments, the system may update the command to reflect the available resource. For example, the command may be updated to call the second dynamic resource. In embodiments, the system may also validate the new resource, ensuring it is compatible with the command and its context. In embodiments, the updated data structure is then stored and/or processed for future use, allowing the system to track changes in resource allocation and ensure that the executed command operates with the most current available resources. Operation 330 may be performed in accordance with the description and embodiments of resource detection module 210 of FIG. 2.

At operation 340, the system (e.g., rendering module 220 of FIG. 2) is configured to render an updated command history based on the updated data structure. For example, the system may dynamically update a user interface (UI) in real time to display the most recent command history, including the updated command reflecting the change that associated the second dynamic resource with the command. In embodiments, this is achieved by modifying the command history view on a user device (e.g., user device 240 of FIG. 2), to display the second dynamic resource (e.g., port: 87) in place of the first dynamic resource (e.g., port: 81). In embodiments, the UI may present the update as a visual change, such as highlighting the dynamic resource field, changing the font color of the dynamic resource field, and/or providing a notification that a change was made. Operation 335 may be performed in accordance with the description and embodiments of rendering module 220 of FIG. 2.

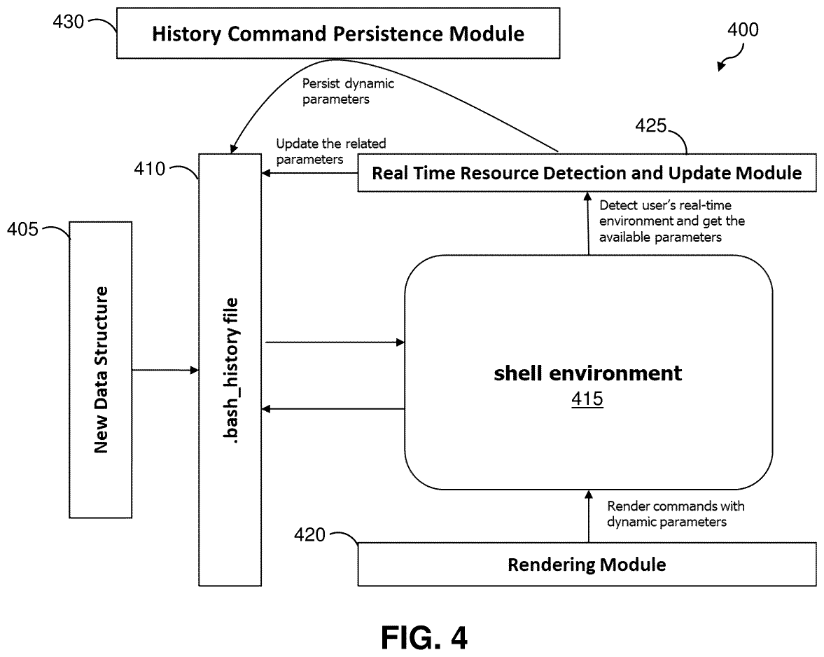

FIG. 4 shows a flow diagram of an exemplary method 400 in accordance with aspects of the present invention. Operations of the method 400 are described with reference to elements and actions depicted in and described with reference to FIGS. 2 and 3.

At operation 405, dynamic shell history command server 205 of FIG. 2 is configured to generate a data structure comprising a command field, a dynamic parameter field, a note field, a flag field, and/or other fields configured to store data related to a command. In embodiments, operation 405 may be carried out in accordance with operation 305 of FIG. 3 and/or in accordance with the descriptions and embodiments of dynamic shell history command server 205 of FIG. 2.

At operation 410, dynamic shell history command server 205 incorporates the data structure generated at operation 405 into a bash_history file. In embodiments, the bash_history file is accessible to and/or transmittable to shell environment 415. For example, the bash_history file can be accessed by other systems and/or users within a network, allowing for the sharing of command histories and/or synchronizing command data across different instances of shell environments.

At operation 420, rendering module 220 is configured to render command histories at a user device (e.g., user device 240 of FIG. 2) via shell environment 415 based on a current state of the bash_history file. In embodiments, if and/or when the bash_history file changes or is updated rendering module 220 renders an updated command history based on the updated bash_history file. In embodiments, operation 420 may be carried out in accordance with operation 335 of FIG. 3 and/or in accordance with the descriptions and embodiments of rendering module 220 of FIG. 2.

At operation 425, resource detection module 210 is configured to detect a user's real time environment (e.g., context) and determine or identify available parameters (e.g., available resources) associated with the user's shell command history. In embodiments, resource detection module 210 may be configured to retrieve command from a command history and determine whether a first dynamic resource (e.g., dynamic parameter) associated with the first command is available. When a resource is unavailable, resource detection module 210 is configured to determine whether another resource is available to execute the command. In embodiments, resource detection module 210 is configured to generate an updated data structure by updating the dynamic parameter field of the data structure to include the second dynamic resource. For example, this is performed by replacing the first dynamic resource (e.g., file path “x”) with the second dynamic resource (e.g., file path “y”) in the dynamic parameter field such that the updated data structure associates the second dynamic resource (e.g., file path “y”) with the command. The updated data structure is incorporated into the bash_history file in accordance with operation 410. In embodiments, operation 425 may be carried out in accordance with operations 310-320 of FIG. 3 and/or in accordance with the descriptions and embodiments of resource detection module 210 of FIG. 2.

At operation 430, history command module 215 is configured to maintain unchanged data structure information, including unchanged dynamic resources. For example, as provided above, history command module 215 ensures that unchanged data structure information remains consistent in the bash_history file, preventing unnecessary updates while still maintaining accurate historical command context. In embodiments, operation 430 may be carried out in accordance with the descriptions and embodiments of rendering module 220 of FIG. 2.

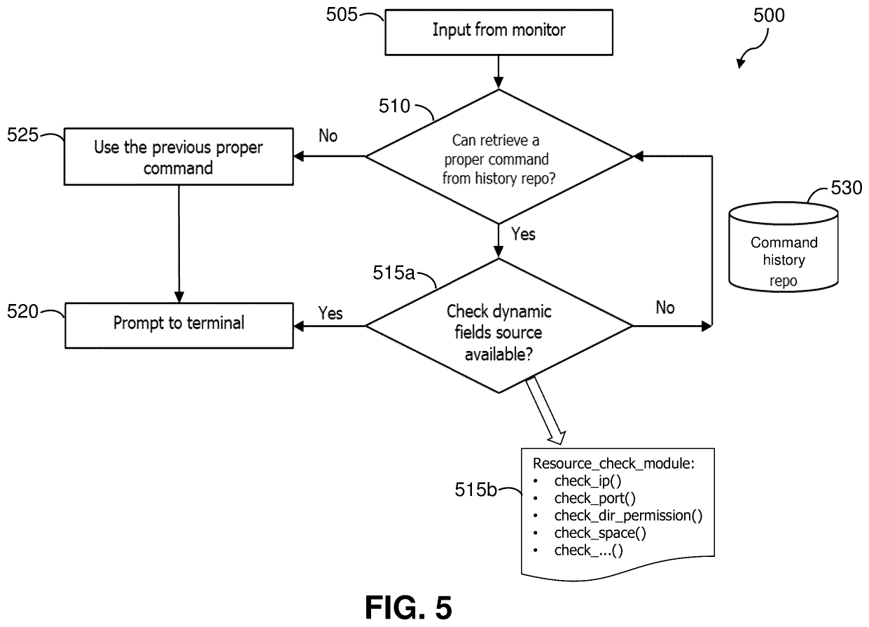

FIG. 5 shows a flowchart of an exemplary method 500 in accordance with aspects of the present invention. Operations of the method 500 are described with reference to elements and actions depicted in and described with reference to FIGS. 2 and 3.

At operation 505, dynamic shell history command server 205 of FIG. 2 initiates method 500 at an occurrence of a user input received from a user device (e.g., user device 240 of FIG. 2). For example, a user may request the user's shell command history. At operation 510, resource detection module 210 of FIG. 2 determines whether a proper command can be retrieved from a command history repository. As used herein, a proper command refers to a command that has valid data, is syntactically correct, and/or is executable without errors. In embodiments, operation 510 may be carried out in accordance with operation 310 of FIG. 3 and/or in accordance with the descriptions and embodiments of resource detection module 210 of FIG. 2

If a proper command can be retrieved from a command history repository at operation 510, resource detection module 210 determines, at operation 515a, whether the dynamic resources associated with the command(s) are available. In embodiments, at operation 515b, resource detection module 210 may run scripts and/or resource availability check functions (e.g., check_ip( ), check_port( ), check_dir_permission( ), check_space). For example, at operation 515b, resource detection module 210 may run a check_ip( ) function to verify whether a remote server IP address is reachable or if the server is down; a check_port( ) function to confirm whether a specific network port used by the command is open or closed; a check_dir_permission( ) function to determine whether the user has the necessary permissions to access a specific directory; a check_space( ) function to verify if sufficient disk space is available for executing the command; and/or other functions for determining and/or identifying a resource availability. Operations 515a and 515b may be performed in accordance with operations 315-320 of FIG. 3 and/or in accordance with the descriptions and embodiments of resource detection module 210 of FIG. 2.

If the dynamic resources associated with the command(s) are available at operation 515a, resource detection module 210 sends the user prompt to a terminal at operation 520, so the user's shell command history can be displayed for the user. Operation 520 may be performed in accordance with operation 335 of FIG. 3 and/or in accordance with the descriptions and embodiments of rendering module 220 of FIG. 2.

If the dynamic resources associated with the command(s) are not available at operation 515a, resource detection module 210 queries the command history repository at operation 530 to determine whether any additional dynamic resources are operable to execute the command.

Operation 530 may be performed in accordance with operation 320 of FIG. 3 and/or in accordance with the descriptions and embodiments of resource detection module 210 of FIG. 2.

If a proper command cannot be retrieved from a command history repository at operation 510, resource detection module 210 determines, at operation 525, to use a previous proper command stored at history command module 215 of FIG. 2. Operation 525 may be performed in accordance with the descriptions and embodiments of rendering module 220 of FIG. 2. In embodiments, history command module 215 may send the user prompt to a terminal at operation 520, so the user's shell command history can be displayed for the user.

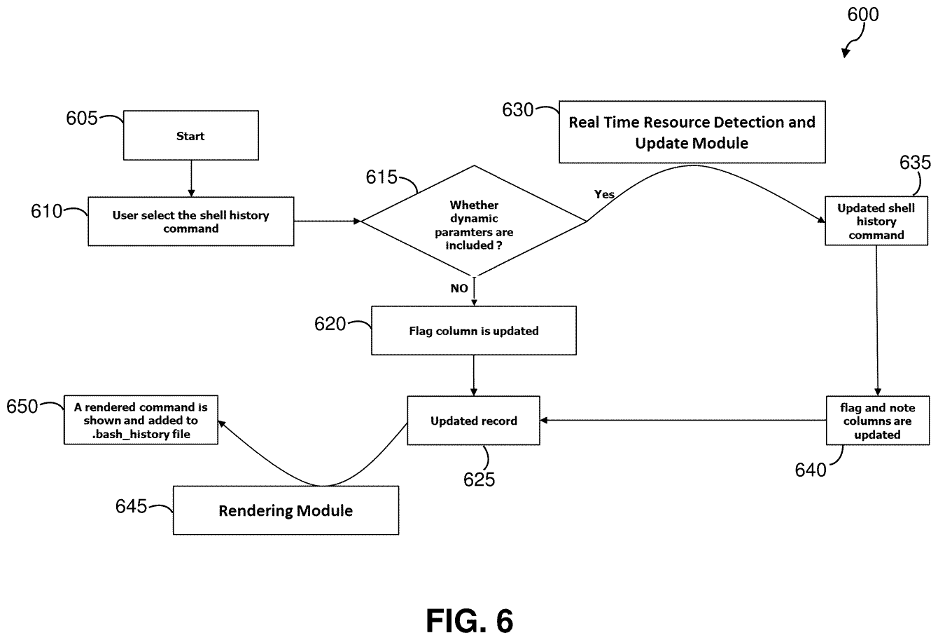

FIG. 6 shows a flowchart of an exemplary method 600 in accordance with aspects of the present invention. Operations of the method 600 are described with reference to elements and actions depicted in and described with reference to FIGS. 2, 3, and 5.

At operation 605, dynamic shell history command server 205 of FIG. 2 initiates method 600. At operation 610, dynamic shell history command server 205 receives a user shell-history command selection from a user device (e.g., user device 240 of FIG. 2).

At operation 615, resource detection module 210 determines whether dynamic parameters (e.g., dynamic resources) are included in the user-selected command. If dynamic parameters are not included and/or called by the user-selected command, resource detection module 210 updates the flag field (e.g., flag column) of a data structure associated with the command at operation 620, to ensure that no flags are set. Ensuring that no flags are set means that no unnecessary updates or modifications will be made to the command and/or data structure at operation 625.

If dynamic parameters are included and/or called by the user-selected command, as determined at operation 615, real time resource detection and update module 630 (e.g., one or more instances of resource detection module 210) is configured to detect the user's real time environment (e.g., context) and determine or identify available parameters (e.g., available resources) associated with the user's shell command history. In embodiments, real time resource detection and update module 630 may be configured to retrieve command from a command history and determine whether a first dynamic resource (e.g., dynamic parameter) associated with the first command is available. When a resource is unavailable, real time resource detection and update module 630 is configured to determine whether another resource is available to execute the command. In embodiments, real time resource detection and update module 630 performs these tasks in accordance with operation 310 of FIG. 3 and/or in accordance with the descriptions and embodiments of resource detection module 210 of FIG. 2.

At operation 635, real time resource detection and update module 630 is configured to generate an updated shell history command by updating the dynamic parameter field of the data structure to include available dynamic resource capable of executing the command. In embodiments, operation 635 may be performed in accordance with operations 310-320 of FIG. 3, in accordance with operation 435 of FIG. 4, and/or in accordance with the descriptions and embodiments of resource detection module 210 of FIG. 2.

At operation 640, real time resource detection and update module 630 is configured to update the flag field (e.g., flag column) and note field (e.g., note column) of the data structure to reflect the updated shell history command generated at operation 635. As noted above, updating the flag field may include setting a flag in the field indicating the presence of a suggested data change. A flag may hold a value such as “true” or “false,” “1” or “0 ,” or other Boolean representations to reflect the status of the change and/or condition. Updating the note field may include generating a plain-text note describing suggested changes to a command, a file path, and/or a dynamic resource (e.g., dynamic parameter) based on the updated shell history command generated at operation 635. For example, if a previously used port is no longer available, resource detection module 210 may generate a note indicating a new port that may be used for executing the associated command. Setting a flag and generating a note provides a way to automatically track potential updates to the command, enabling the system to notify users and/or trigger automated corrections. This also allows for more dynamic and efficient handling of commands, as the system can proactively suggest and/or apply resource changes in response to availability issues. In embodiments, operation 640 may be performed in accordance with operation 325 of FIG. 3 and/or in accordance with the descriptions and embodiments of resource detection module 210 of FIG. 2.

At operation 625, when a data structure's flag field indicates the presence of a suggested data change, real time resource detection and update module 630 is configured to generate an updated data structure by merging an updated dynamic resource into the dynamic parameter field of the bash_history file. For example, when a dynamic resource requires updating, the data structure is updated to reflect the change and/or to reflect the updated information to provide the available dynamic resource. This ensures that the dynamic parameter field in the bash_history file always contains the most current and relevant information, such as an updated IP address, file path, and/or available disk space, reflecting any changes to the system, environment, and or context the user is working in. In embodiments, operation 625 may be performed in accordance with operation 330 of FIG. 3 and/or in accordance with the descriptions and embodiments of resource detection module 210 of FIG. 2.

At operation 650, rendering module 645 (e.g., one or more instances of rendering module 220) renders the updated command from operation 625 at a user device and adds the updated command to a bash_history file for future use. In embodiments, operation 50 may be performed in accordance with operation 335 of FIG. 3 and/or in accordance with the descriptions and embodiments of rendering module 220 of FIG. 2.

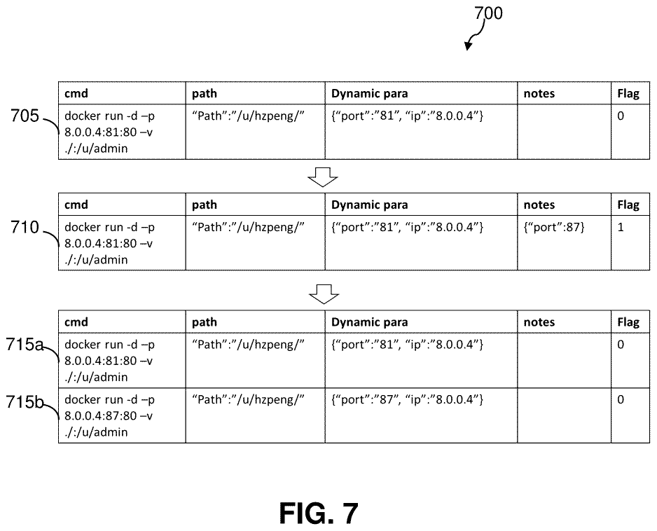

FIG. 7 shows a flowchart of an exemplary data structure 700 in accordance with aspects of the present invention. FIG. 7 provides an exemplary use case for how the described data structure is dynamically updated by adjusting parameters based on real-time resource availability. Features of data structure 700 are described with reference to elements and actions depicted in and described with reference to FIGS. 2 and 3.

Data structure row 705 comprises five fields (e.g., columns), including a cmd field (e.g., command field), a path field (e.g., data path field), a dynamic para field (e.g., dynamic parameter field), a notes field (e.g., note field), and a flag field. Data structure row 705 shows a command as previously used by a user that could be rendered at a user device in a shell history.

In embodiments, the system (e.g., resource detection module 210 of FIG. 2) may determine that a dynamic parameter (e.g., port: 81) of data structure row 705 is not available in the user's real time context. In such embodiments, the system may identify another dynamic parameter (e.g., port: 87) capable of executing the command is available. Data structure row 710 shows that the system determined that the previously used dynamic parameter (e.g., port: 81) is not available and shows that a flag has been set in the flag field, indicating the presence of a suggested data change. Data structure row 710 also shows a plain-text note indicating that another dynamic parameter (e.g., port: 87) capable of executing the command is available. The changes made from data structure row 705 to row 710 may be performed in accordance with operations 310-325 of FIG. 3 and/or in accordance with the descriptions and embodiments of resource detection module 210 of FIG. 2.

Data structure row 715a shows the old data structure that may be stored in a command history repository (e.g., data source 230) for future use. Data structure row 715b shows an updated data structure having the new and/or updated dynamic parameter in the dynamic para field and the note in the notes field and flag in the flag field have been removed, responsive to the new and/or updated dynamic parameter. In embodiments, the data structure row 715b may be rendered for a user at a user device in real time. In this manner, the system provides an updated dynamic shell history that uses and/or calls dynamic resources (e.g., dynamic parameters) that are available based on the user's current context. This improves existing technologies by enhancing automation by dynamically adjusting command execution based on context-aware parameters, streamlining workflows by ensuring that only relevant and updated parameters are utilized in command history, and by reducing manual intervention and improving system responsiveness to real-time data changes and resource availability.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
generating a data structure comprising a command field and a dynamic parameter field;
retrieving a first command from a command history repository, wherein the dynamic parameter field of the data structure for the first command indicates that a first dynamic resource is used for execution of the first command;
determining that the first dynamic resource indicated for the execution of the first command is unavailable;
determining that a second dynamic resource not indicated by the dynamic parameter field of the data structure for the first command is available to execute the first command;
generating, based on the determination that the second dynamic resource is available to execute the first command, an updated data structure for the first command by updating the dynamic parameter field to include the second dynamic resource; and
rendering, at a user device in real time, an updated command history based on the updated data structure.

2. The method of claim 1, wherein the data structure further comprises a field indicating a presence of a suggested data change.

3. The method of claim 2, further comprising setting a flag in the field indicating the presence of the suggested data change.

4. The method of claim 3, further comprising removing the flag in response to making the suggested data change.

5. The method of claim 1, wherein the updated data structure is further generated based on a context change associated with a user input.

6. The method of claim 5, wherein the context comprises a variable selected from a group consisting of an environment variable, a current state variable, and an available system resource variable.

7. The method of claim 1, wherein the first dynamic resource is a resource selected from a group consisting of an internet protocol address, a file path, a port number, a directory permission, and an amount of available disk space.

8. The method of claim 1, wherein generating the updated data structure further comprises:
removing the first dynamic resource from the dynamic parameter field; and
updating the first command to call the second dynamic resource.

9. A computer program product comprising:
one or more computer-readable storage media; and
program instructions stored on the one or more computer-readable storage media to perform operations comprising:
generating a data structure comprising a command field and a dynamic parameter field;
retrieving a first command from a command history repository, wherein the dynamic parameter field of the data structure for the first command indicates that a first dynamic resource is used for execution of the first command;
determining that the first dynamic resource indicated for the execution of the first command is unavailable;
determining that a second dynamic resource not indicated by the dynamic parameter field of the data structure for the first command is available to execute the first command;
generating, based on the determination that the second dynamic resource is available to execute the first command, an updated data structure for the first command by updating the dynamic parameter field to include the second dynamic resource; and
rendering, at a user device in real time, an updated command history based on the updated data structure.

10. The computer program product of claim 9, wherein the data structure further comprises a field indicating a presence of a suggested data change.

11. The computer program product of claim 10, wherein the operations further comprise setting a flag in the field indicating the presence of the suggested data change.

12. The computer program product of claim 11, wherein the operations further comprise removing the flag in response to making the suggested data change.

13. The computer program product of claim 9, wherein the updated data structure is further generated based on a context change associated with a user input.

14. The computer program product of claim 13, wherein the context comprises a variable selected from a group consisting of an environment variable, a current state variable, and an available system resource variable.

15. A computer system comprising:
a processor set;
one or more computer-readable storage media; and
program instructions stored on the one or more computer-readable storage media to cause the processor set to perform operations comprising:
generating a data structure comprising a command field and a dynamic parameter field;
retrieving a first command from a command history repository, wherein the dynamic parameter field of the data structure for the first command indicates that a first dynamic resource is used for execution of the first command;
determining that the first dynamic resource indicated for the execution of the first command is unavailable;
determining that a second dynamic resource not indicated by the dynamic parameter field of the data structure for the first command is available to execute the first command;
generating, based on the determination that the second dynamic resource is available to execute the first command, an updated data structure for the first command by updating the dynamic parameter field to include the second dynamic resource; and
rendering, at a user device in real time, an updated command history based on the updated data structure.

16. The computer system of claim 15, wherein the data structure further comprises a field indicating a presence of a suggested data change.

17. The computer system of claim 16, wherein the operations further comprise setting a flag in the field indicating the presence of the suggested data change.

18. The computer system of claim 17, wherein the operations further comprise removing the flag in response to making the suggested data change.

19. The computer system of claim 15, wherein the first dynamic resource is a resource selected from a group consisting of an internet protocol address, a file path, a port number, a directory permission, and an amount of available disk space.

20. The computer system of claim 15, wherein generating the updated data structure further comprises removing the first dynamic resource from the dynamic parameter field and updating the first command to call the second dynamic resource.
